(19) United States
(12) Patent Application Publication
(10) Pub. No.: US 2015/0141561 A1
(43) Pub. Date: May 21, 2015

(54) CARBOXY SILICONE CONTAINING COMPOSITION AND PROCESS FOR PREPARING THE COMPOSITION

(71) Applicant: DOW CORNING TORAY CO., LTD., CHIYODA-KU, TK (JP)

(72) Inventors: Masakado Kennoki, Ichihara-shi (JP); Jianren Zeng, Chuo-ku (JP)

(21) Appl. No.: 14/405,818

(22) PCT Filed: Jun. 7, 2013
(86) PCT No.: PCT/GB2013/051511

§ 371 Date: Dec. 5, 2014

Related U.S. Application Data
(60) Provisional application No. 61/657,246, filed on Jun. 8, 2012.

(51) Int. Cl. C08L 83/06

(52) U.S. Cl. CPC C08L 83/06; C08L 2205/025
USPC 524/266; 524/588

(57) ABSTRACT

A silicone composition comprises: (A) a silicone based antifoam agent and (B) a carboxy functional silicone. Optionally, the silicone composition further comprises at least one of: (C) an emulsifier selected from a silicone polyether emulsifier, an organic emulsifier, or mixtures thereof, or (D) a hydroxy compound selected from a glycol, water, or mixtures thereof. A process for preparing the silicone composition comprises the step of: combining (A), (B), and optionally at least one of (C) or (D).

### CROSS REFERENCE TO RELATED APPLICATIONS

This application claims priority from U.S. provisional application 61/657,246 filed on Jun. 8, 2012.

### FIELD OF THE INVENTION

This invention relates to silicone antifoam compositions containing carboxy silicone. Dilution stability of antifoam compositions is an important requirement for their use in many applications. However, it is difficult to achieve the dilution stability especially at high temperature. It was found here that by incorporating a carboxy silicone, it is even possible to achieve good dilution stability at both room temperature and high temperature.

### BACKGROUND OF THE INVENTION

Aqueous emulsions of silicone are widely used in various purposes as anti-foaming agents, foam stabilizers, release agents, water repellents and so forth, but in many instances the emulsions are required to be readily diluted with water, to be stable, and, in particular, to have a dilution stability.

Silicone antifoam emulsions may contain among other components, organopolysiloxanes and hydrophobic fillers. Often the hydrophobic fillers present in the antifoam compositions make the emulsions unstable. Consequently, the mechanical stability with respect to the processes necessarily encountered in fibre treatment (agitation, circulation, expression of the treatment bath, etc.), the dilution stability (for example, 20-fold to 100-fold dilution with water), and the blending stability with regard to use with additives are all unsatisfactory. As a consequence, such an antifoam emulsion undergoes de-emulsification, and the organopolysiloxane floats to the top of the treatment bath. It will then appear as oil drops (oil spots) on the fibrous material, thus generating the serious problem of “staining.”

### SUMMARY OF THE INVENTION

The present invention relates to a silicone composition comprising:
(A) a silicone based antifoam agent,
(B) a carboxy functional silicone, and optionally at least one of;
(C) an emulsifier selected from a silicone polyether emulsifier, an organic emulsifier, or mixtures thereof, and
(D) a hydroxy compound selected from a glycol, water or mixtures thereof.
   The present invention also relates to a process for preparing a silicone composition which comprises the steps of:
   combining (A) a silicone based antifoam agent, (B) a carboxy containing silicone, and optionally at least one of (C) an emulsifier selected from a silicone polyether emulsifier and an organic emulsifier, and mixtures thereof, and (D) a hydroxy compound selected from a glycol and water and mixtures thereof.

### DETAILED DESCRIPTION OF THE INVENTION

All amounts, ratios, and percentages are by weight unless otherwise indicated. The following is a list of definitions as used in this application.

### Definitions

The terms “a” and “an” each mean one or more.
The abbreviation “M” means a siloxy unit of formula R₃SiO_{1/2}, where each R independently represents a monovalent atom or group.
The abbreviation “D” means a siloxy unit of formula R₂SiO_{2/2}, where each R independently represents a monovalent atom or group.
The abbreviation “T” means a siloxy unit of formula RSiO_{3/2}, where R represents a monovalent atom or group.
The abbreviation “Q” means a siloxy unit of formula SiO_{4/2}.
The abbreviation “Me” represents a methyl group.
The abbreviation “Ph” represents a phenyl group.
The abbreviation “Vi” represents a vinyl group.

### (A) The Silicone Based Antifoam Agent

The silicone based antifoam agent (A) comprises a mixture of
(a) 100 parts by weight of a polysiloxane fluid wherein the polysiloxane fluid is a linear polysiloxane fluid, a branched polysiloxane fluid, or mixtures thereof and
(b) from 1 to 15 parts by weight of a hydrophobic filler dispersed in the polydiorganosiloxane fluid.
   The polysiloxane fluid (a) is a linear polysiloxane fluid, a branched polysiloxane fluid, or mixtures thereof. The linear polydiorganosiloxane has a formula

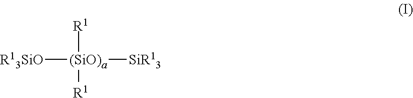

wherein R¹ is independently an alkyl group having from 1 to 36 carbon atoms, an alkenyl group having from 2 to 6 carbon atoms, an aryl group, an aralkyl group having up to 36 carbon atoms, a hydroxy group, or an alkoxy group wherein the alkyl group of the alkoxy group has from 1 to 36 carbon atoms and subscript a is an integer of from 1 up to 2000. Alternatively R¹ is methyl. Alternatively subscript a is from 1 to 1500, alternatively from 1 to 500.

One example of a branched polydiorganosiloxane has a formula

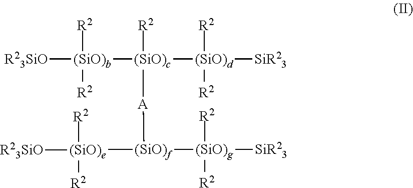

wherein R² is independently an alkyl group having from 1 to 36 carbon atoms, an alkenyl group having from 2 to 6 carbon atoms, an aryl group, an aralkyl group having up to 36 carbon atoms, a hydroxy group, or an alkoxy group wherein the alkyl group of the alkoxy group has from 1 to 36 carbon atoms. Alternatively R² is methyl. Subscript b is an integer of from 1 up to 1000, alternatively from 1 to 500, alternatively from 1 to 250. Subscript c is an integer of from greater than zero up to 30 and alternatively from 1 to 15. Subscript d is an integer of from 1 up to 1000, alternatively from 1 to 100, alternatively from 1 to 50. Subscript e is an integer of from 1 up to 1000, alternatively from 1 to 500, alternatively from 1 to 250. Subscript f is from greater than zero to 30, alternatively from greater than zero to 20, alternatively from 1 to 15. Subscript g is an integer of from 1 up to 1000, alternatively from 1 to 100, alternatively from 1 to 50. A is a group selected from

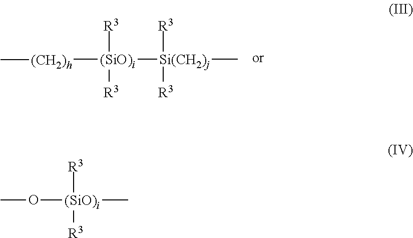

wherein R³ is independently an alkyl group having from 1 to 36 carbon atoms or an aryl group or aralkyl group having up to 36 carbon atoms. Alternatively R³ is methyl. Subscript h is an integer of from 2 up to 10 and alternatively from 2 to 6. Subscript i is an integer of from 1 up to 2000, alternatively from 1 to 1000, and alternatively from 20 to 500. Subscript j is an integer of from 2 up to 10 and alternatively from 2 to 6.

Another example for the preparation of a branched polysiloxane fluid involves the reaction of a polysiloxane having a hydrogen atom in its side chains with a polysiloxane having vinyl end groups per the equation below

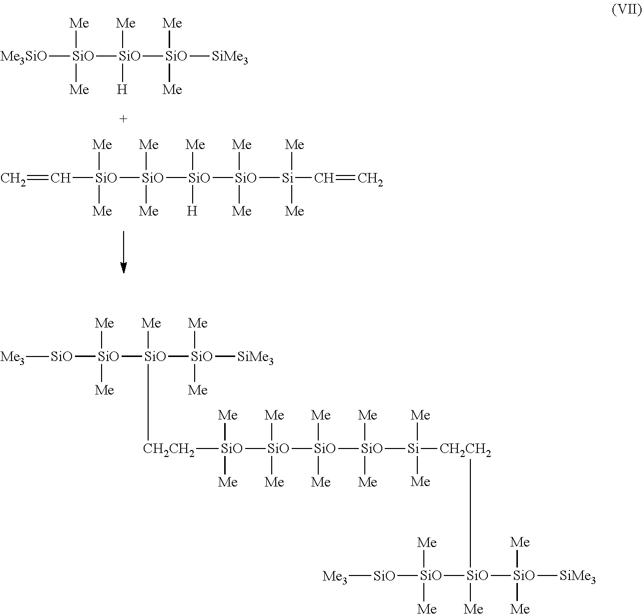

Another example for the preparation of a branched polysiloxane fluid involves the reaction of a polysiloxane having hydroxy atoms in its side chains with a polysiloxane having hydroxy atoms in a terminal position per the equation below

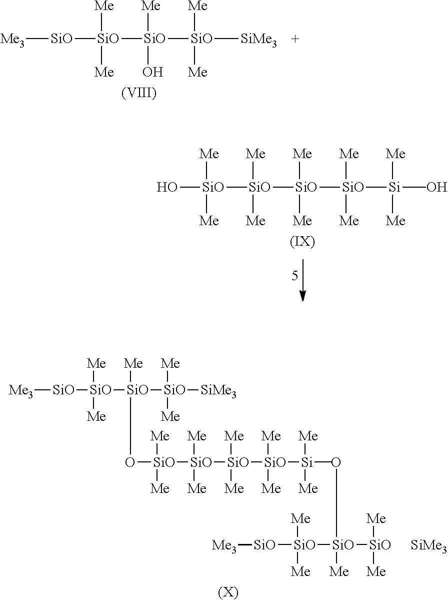

Another example for the preparation of a branched polysiloxane fluid involves the reaction of an organosilicon silane, such as methyltriethoxysilane with a polysiloxane having hydroxy atoms in an internal position per the equations below.

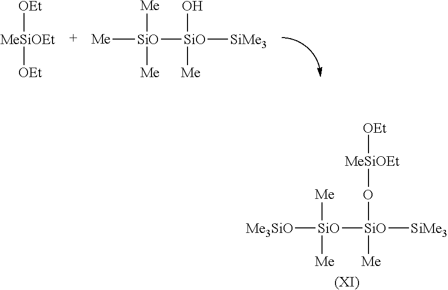

Another example for the preparation of a branched polysiloxane is the reaction of a hydroxy containing compound and an aminoxy containing compound as outlined below.

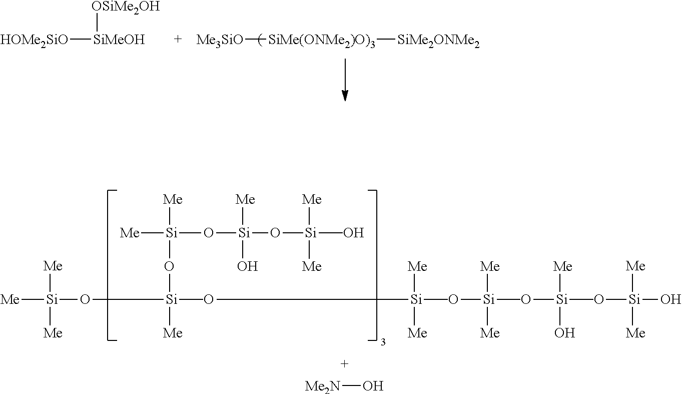

The branched polysiloxane fluid can also be a resin comprising at least one of compounds a) to d):
a) an organosilicon compound of the general formula R¹⁴_{α}SiX_{4-α}. R¹⁴ is a monovalent hydrocarbon group having one to five carbon atoms. X is a hydrolyzable group, such as —OR¹⁵ or —OR¹⁶OR¹⁷. R¹⁶ is a divalent hydrocarbon group having one to five carbon atoms and R¹⁵ or R¹⁷ are each hydrogen or a monovalent hydrocarbon group having one to five carbon atoms. The average value of subscript α does not exceed 1. Therefore, this compound is one of the formula R¹⁴SiX₃ or SiX₄, or a mixture thereof. These organic silicon compounds are well known in the silicone industry and examples thereof include CH₃Si(OCH₃)₃, CH₃Si(OC₂H₅)₃, CH₂═CHSi(OCH₃)₃, C₆H₅Si(OC₂H₅)₄, Si(OC₂H₅)₄, CH₂═CHSi(OC₂H₅)₃ and Si(OC₂H₄OC₂H₅)₄.
b) A partially hydrolyzed condensate of the compound a). This condensate can be prepared by a known method.
c) A siloxane resin consisting essentially of (CH₃)₃SiO_{1/2} and SiO₂ units and having a (CH₃)₃SiO_{1/2}SiO₂ ratio of 0.41 to 1.21. Siloxane resins of this formula are commercially available. They are produced by the cohydrolysis and condensation of (CH₃)₃SiCl and SiCl₄ or the reaction between (CH₃)₃SiCl with a silicate solution. A siloxane resin usually contains residual amounts of hydroxyl groups, e.g., about 2 to 5% by weight. The residual hydroxyl group can be decreased to substantially zero by a known method, if desired. All of these siloxane resins are usable for the purpose of this invention irrespective of the amount of the residual hydroxyl group.
d) A condensate of the siloxane resin c) with the compound a) or b). Condensation of siloxane resin with hydrolyzable silanes can be accomplished by a known method.

One example of a polysiloxane fluid is a polysiloxane comprising at least 10% diorganosiloxane units of the formula

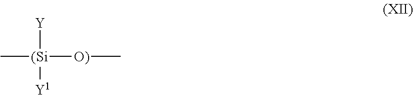

and up to 90% diorganosiloxane units of the formula

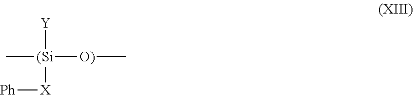

wherein X denotes a divalent aliphatic organic group bonded to silicon through a carbon atom; Ph denotes an aromatic group; Y denotes an alkyl group having 1 to 4 carbon atoms; and Y¹ denotes an aliphatic hydrocarbon group having 1 to 24 carbon atoms. The diorganosiloxane units containing a —X-Ph group comprise from 5 to 60% of the diorganosiloxane units in the fluid. The group X is a divalent alkylene group having from 2 to 10 carbon atoms, alternatively 2 to 4 carbon atoms, but may contain an ether linkage between two alkylene groups or between an alkylene group and -Ph, or may contain an ester linkage. Ph is a phenyl group, but may be substituted for example by one or more methyl, methoxy, hydroxy or chloro group, or two substituents on the Ph group may together form a divalent alkylene group, or may together form an aromatic ring, resulting in conjunction with the Ph group in e.g. a naphthalene group. A particularly preferred X-Ph group is 2-phenylpropyl —CH₂—CH(CH₃)—C₆H₅. The group Y is methyl but can be ethyl, propyl or butyl. The group Y¹ has 1 to 18, alternatively 2 to 16, carbon atoms, for example ethyl, methyl, propyl, isobutyl or hexyl. Mixtures of alkyl groups Y¹ can be used, for example ethyl and methyl, or a mixture of dodecyl and tetradecyl. Other groups may be present, for example haloalkyl groups such as chloropropyl, acyloxyalkyl or alkoxyalkyl groups or aromatic groups such as phenyl bonded direct to Si.

The polysiloxane fluid containing —X-Ph groups may be a substantially linear siloxane polymer or may have some branching, for example branching in the siloxane chain by the presence of some tri-functional siloxane units, or branching by a multivalent, e.g. divalent or trivalent, organic or silicon-organic moiety linking polymer chains.

An alternative example of a polysiloxane fluid is a polysiloxane comprising 50-100% diorganosiloxane units of the formula

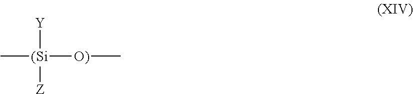

and optionally up to 50% diorganosiloxane units of the formula

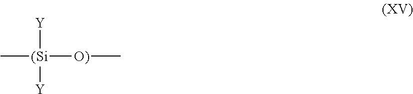

wherein Y denotes an alkyl group having 1 to 4 carbon atoms and Z denotes an alkyl group having 6 to 18 carbon atoms. The groups Y in such a polydiorganosiloxane are preferably methyl or ethyl. The alkyl group Z may preferably have from 6 to 12 or 14 carbon atoms, for example octyl, hexyl, heptyl, decyl, or dodecyl, or a mixture of dodecyl and tetradecyl.

The number of siloxane units (DP or degree of polymerization) in the average molecule of the polysiloxane fluid of either of the above types is at least 5, alternatively from 10 to 5000. Particularly preferred are polysiloxanes with a DP of from 20 to 1000, alternatively 20 to 200. The end groups of the polysiloxane can be any of those conventionally present in siloxanes, for example trimethylsilyl end groups.

The polysiloxane fluid containing —X-Ph groups, or the polysiloxane fluid containing —Z groups, is present as at least 80% by weight of the polysiloxane fluid content of the silicone based antifoam agent, alternatively as 100% or more than 95% of the polysiloxane fluid.

Alternatively, the polysiloxane fluid can be a polysiloxane in which the organic groups are substantially all alkyl groups having 2 to 4 carbon atoms, for example, polydiethylsiloxane, polydipropylsiloxane, polydibutylsiloxane, polymethylethylsiloxane, polymethylpropylsiloxane, polymethylbutylsiloxane, polyethylpropylsiloxane, polyethylbutylsiloxane, and polypropylbutylsiloxane.

Within the polysiloxane fluid, the mean number of carbon atoms in the groups R above is preferably at least 1.3, and is more preferably at least 2.0, most preferably at least 2.5, if the groups R¹ do not include aryl or aralkyl groups. The polysiloxane fluid is free from non-silicone polymer chains such as polyether chains.

The silicone based antifoam agent contains a hydrophobic filler (b) dispersed in the polysiloxane fluid. Hydrophobic fillers for silicone based antifoam agents are well known and are particulate materials, such as silica, preferably with a surface area as measured by BET measurement of at least 50 m²/g., titania, ground quartz, alumina, an aluminosilicate, zinc oxide, magnesium oxide, a salt of an aliphatic carboxylic acids, a reaction product of an isocyanate with an amine, e.g. cyclohexylamine, or an alkyl amide such as ethylenebisstearamide or methylenebisstearamide. Mixtures of two or more of these can be used.

Some of the fillers mentioned above are not hydrophobic in nature, but can be used if made hydrophobic. This can be done either in situ (i.e. when dispersed in the polysiloxane fluid), or by pre-treatment of the filler prior to mixing with the polysiloxane fluid. An alternative filler is silica which is made hydrophobic. Preferred silica materials are those which are prepared by heating, e.g. fumed silica, or precipitation. The silica filler may for example have an average particle size of 0.5 to 50 μm, alternatively 2 to 30 and alternatively 5 to 25 μm. It can be made hydrophobic by treatment with a fatty acid, but is preferably made hydrophobic by the use of methyl substituted organosilicon materials such as dimethylsiloxane polymers which are end-blocked with silanol or silicon-bonded alkoxy groups, hexamethyldisilazane, hexamethyldisiloxane or organosilicon resins containing (CH₃)₃SiO_{1/2} groups and silanol groups. Hydrophobing is generally carried out at a temperature of at least 100° C. Mixtures of fillers can be used, for example a highly hydrophobic silica filler such as that sold under the Trade Mark ‘Sipemat D10’ can be used together with a partially hydrophobic silica such as that sold under the Trade Mark ‘Aerosil R972’.

The amount of hydrophobic filler (A)(b) in the silicone based antifoam agent of the invention is from 1 to 15 parts by weight based on 100 parts of the polysiloxane fluid (A)(a), alternatively from 1 up to 10 parts by weight, and alternatively from 2 to 8 parts by weight.

The silicone based antifoam agent may further comprise at least one of (A)(c) a polydiorganosiloxane having at least one terminal hydroxy group and (A)(d) an organosilicon resin which enhances the foam control efficiency of the polydiorganosiloxane fluid.

Alternatively the polydiorganosiloxane (A)(c) is represented by the formula

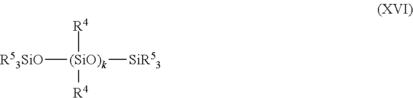

wherein R⁴ is independently a monovalent hydrocarbon group or a substituted monovalent hydrocarbon group having from 1 to 20 carbon atoms, R⁵ is independently a monovalent hydrocarbon group or a substituted monovalent hydrocarbon group having from 1 to 20 carbon atoms, or a hydroxy group, with the proviso that at least one R⁵ is a hydroxy group, and subscript k is less than 1500, alternatively from 10 to 1000, alternatively from 10 to 500.

The amount of polydiorganosiloxane (A)(c) when used in the silicone based antifoam agent of the invention is from 10 to 125 parts by weight based on 100 parts of the polysiloxane fluid (A)(a), alternatively from 15 up to 100 parts by weight, and alternatively from 20 up to 80 parts by weight.

The silicone based antifoam agent may further comprise (A)(d) an organosilicon resin which enhances the foam control efficiency of the polydiorganosiloxane fluid. In such polydiorganosiloxane fluids, the resin modifies the surface properties of the fluid.

The organosilicon resin (A)(d) is generally a non-linear siloxane resin of the empirical formula R⁶_{y}SiO_{(4-y)/2} wherein R⁶ denotes a hydroxyl, hydrocarbon or hydrocarbyloxy group, and wherein subscript y has an average value of from 0.5 to 2.4. It preferably consists of monovalent trihydrocarbonsiloxy (M) groups of the formula R⁶₃SiO_{1/2} and tetrafunctional (Q) groups SiO_{4/2} wherein R⁶ is an alkyl group having 1 to 6 carbon atoms, for example methyl or ethyl, or can be phenyl. The number ratio of M groups to Q groups is preferably in the range 0.4:1 to 2.5:1 (equivalent to a value of subscript y in the formula R⁸_{y}SiO_{(4-y)/2} of 0.86 to 2.15), alternatively from 0.4:1 to 1.1:1 and alternatively from 0.5:1 to 0.8:1 (equivalent to y=1.0 to y=1.33).

The organosilicon resin (A)(d) is preferably a solid at room temperature. The molecular weight of the resin can be increased by condensation, for example by heating in the presence of a base. The base can for example be an aqueous or alcoholic solution of potassium hydroxide or sodium hydroxide, e.g. a solution in methanol or propanol. A resin comprising M groups, trivalent R⁸SiO_{3/2} (T) units and Q units can alternatively be used, or up to 20% of units in the organosilicon resin can be divalent units R⁸₂SiO_{2/2}. The group R⁷ is an alkyl group having 1 to 6 carbon atoms, for example methyl or ethyl, or can be phenyl. It is particularly preferred that at least 80%, most preferably substantially all, R⁷ groups present are methyl groups. The resin may be a trimethyl-capped resin.

The organosilicon resin (A)(d) is generally a non-linear siloxane resin and preferably consists of siloxane units of the formula R¹⁸_{β}SiO_{4-β/2} wherein R¹⁸ denotes a hydroxyl, hydrocarbon or hydrocarbonoxy group and wherein subscript β has an average value of from 0.5 to 2.4. The resin preferably consists of monovalent trihydrocarbonsiloxy (M) groups of the formula R¹⁹₃SiO_{1/2} and tetrafunctional (Q) groups SiO_{4/2} wherein R¹⁹ denotes a monovalent hydrocarbon group. The number ratio of M groups to Q groups is preferably in the range 0.4:1 to 2.5:1 (equivalent to a value of β in the formula R¹⁸_{β}SiO_{4-β/2} of 0.86 to 2.15), and is more preferably 0.4:1 to 1.1:1 and most preferably 0.5:1 to 0.8:1 (equivalent to β=1.0-1.33) for use in laundry detergent applications. The organosilicon resin (A)(d) is preferably a solid at room temperature, but MQ resins having a M/Q ratio of higher than 1.2, which are generally liquid, can be used successfully. Although it is most preferred that the resin (A)(d) consists only of M and Q groups as defined above, a resin comprising M groups, trivalent R¹⁹SiO_{3/2} (T) groups and Q groups can alternatively be used. The organosilicon resin (A)(d) can also contain R¹⁹₂SiO_{2/2} siloxy units, preferably at no more than 20% of all siloxane units present. The group R¹⁹ is preferably an alkyl group having from 1 to 6 carbon atoms, most preferably methyl or ethyl, or phenyl. It is particularly preferred that at least 80%, and most preferably substantially all of the R¹⁹ groups present are methyl groups. Other hydrocarbon groups may also be present, e.g. alkenyl groups present for example as dimethylvinylsilyl units, preferably in small amounts, most preferably not exceeding 5% of all R¹⁹ groups. Silicon bonded hydroxyl groups and/or alkoxy, e.g. methoxy, groups may also be present.

Such organosilicon resins are well known. They can be made in solvent or in situ, e.g. by hydrolysis of certain silane materials. Particularly preferred is the hydrolysis and condensation in the presence of a solvent, e.g. xylene, of a precursor of the tetravalent siloxy unit (e.g. tetra-orthosilicate, tetraethyl orthosilicate, polyethyl silicate or sodium silicate) and a precursor of mono-valent trialkylsiloxy units (e.g. trimethylchlorosilane, trimethylethoxysilane, hexamethyldisiloxane or hexa-methyldisilazane). The resulting MQ resin can if desired be further trimethylsilylated to react out residual Si—OH groups or can be heated in the presence of a base to cause self-condensation of the resin by elimination of Si—OH groups or condensation reaction with the residual SiOH from the particulate filler (silica) and polyorganosiloxane polymer.

The amount of the organosilicon resin (A)(d) when used in the silicone based antifoam agent of the invention is from 0.5 to 10 parts by weight based on 100 parts of the polysiloxane fluid (A)(a), alternatively from 0.75 to 7.5 parts by weight, and alternatively from 1 up to 70 parts by weight.

### (B) The Carboxy Functional Silicone

The carboxy functional silicone (B) is an organopolysiloxane having at least one siloxy unit in its formula containing a COOH group and having the formula

R⁸₂R⁹SiO(R⁸R⁹SiO)ₗ(R⁸₂SiO)ₘSiR⁹R⁸₂ or (XVII)

R⁸₂R⁹SiO(R⁸R⁹SiO)ₗSiR⁹R⁸₂ (XVIII)

wherein R⁸ is an alkyl group having from 1 to 20 carbon atoms, R⁹ is independently selected from R⁸ and R¹⁰COOH, wherein R¹⁰ is a divalent hydrocarbon group having from 1 to 20 carbon atoms, with the proviso that at least one R⁹ is R¹⁰COOH, subscript l is from 0 up to 1000, and subscript m is from 1 up to 400.

The carboxy containing silicone may be prepared by reacting an unsaturated carboxylic acid with a silazane according to the below reaction to obtain component (B)(a).

CH₂═CH—(CH₂)ₙCOOH+HN(SiMe₃)₂→CH₂═CH₂—(CH₂)ₙCOOSiMe₃+NH₃ (B)(a)

Component (B)(a) is reacted with an organohydrogenpolysiloxane containing at least one silicon-bonded hydrogen atom per molecule in an amount that the molar ratio of the total number of the silicon-bonded hydrogen atoms of the organohydrogenpolysiloxane to the total quantity of all alkenyl radicals of component (B)(a) is on a molar basis according to the below reaction to obtain component (B)(b).

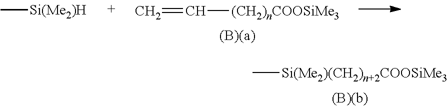

Component (B)(b) is reacted with methyl alcohol according to the below reaction to obtain component (B).

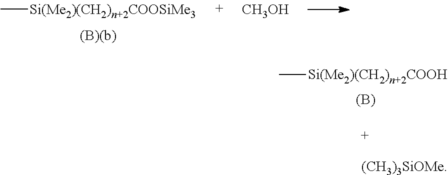

The expression —(CH₂)ₙ₊₂COOH is R¹⁰COOH wherein subscript n is from 0 to 18.

### (C) The Optional Emulsifier

The emulsifier is an optional component and is selected from a silicone polyether emulsifier, an organic emulsifier, and mixtures thereof.

The silicone polyether is selected from

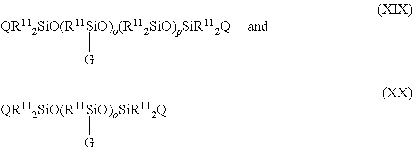

wherein R¹¹ is a monovalent hydrocarbon group having from 1 to 20 carbon atoms, Q is independently R¹¹ or G, with the proviso that at least one Q is G, subscript o has a value of 0 to 150, subscript p has a value of 1 to 400 and G is a polyoxyalkylene group having its formula selected from

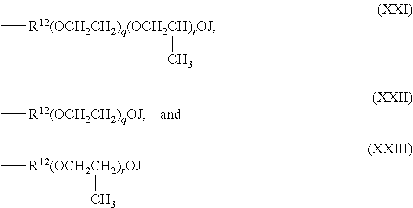

wherein R¹² is a divalent hydrocarbon group having 1 to 20 carbon atoms, subscript q has an average value of about 1 to 50, subscript r has an average value of 1 to about 50 and J is selected from the group consisting of hydrogen, an alkyl radical having 1 to 6 carbon atoms and an acyl group having 2 to 6 carbon atoms.

Monovalent hydrocarbon groups suitable as R¹¹ include alkyl radicals, such as methyl, ethyl, propyl, butyl, hexyl, octyl, and decyl; cycloaliphatic groups, such as cyclohexyl; aryl groups such as phenyl, tolyl, and xylyl; arylalkyl groups such as benzyl and phenylethyl. Highly preferred monovalent hydrocarbon groups are methyl and phenyl. Monovalent halogenated hydrocarbon groups include any monovalent hydrocarbon radical noted above and has at least one of its hydrogen atoms replaced with a halogen, such as fluorine, chlorine, or bromine. The group R¹² hereinabove is a divalent hydrocarbon group having from 1 to 20 carbon atoms which is exemplified by groups such as alkylene radicals including methylene, ethylene, propylene, butylene, phenylene, trimethylene, 2-methyltrimethylene, pentamethylene, hexamethylene, 3-ethyl-hexamethylene, octamethylene, —CH₂(CH₃)CH—, —CH₂CH(CH₃)CH₂—, and —(CH₂)₁₈—, cycloalkylene radicals such as cyclohexylene, arylene radicals such as phenylene, combinations of divalent hydrocarbon radicals such as benzylene (—C₆H₄CH₂—), hydroxylated hydrocarbon residues, chloroethylene, fluoroethylene, —CH₂CH₂CH₂OCH₂—, —CH₂CH₂OCH₂CH₂—, —CH₂CH₂OCH(CH₃)CH₂—, and —CH₂OCH2CH₂OCH₂CH₂—. Alternatively both Q and R¹¹ of component (B) are methyl radicals and that R¹² is the trimethylene group. Alternatively subscript o is between 1 and 10, subscript p is between 0 and 100, and subscript q and subscript r are between 7 and 12. The silicone glycols are well known in the art, many of these being available commercially, and further description thereof is considered unnecessary.

The organic emulsifier is selected from alkoxylated alcohols and alkoxylated carboxylic acids. The alkoxylated alcohols are formed by the reaction of an alcohol with ethylene oxide, propylene oxide, or a mixture of ethylene oxide and propylene oxide and have the formula

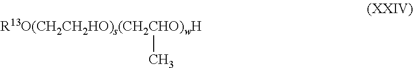

The alkoxylated carboxylic acids are formed by the reaction of a carboxylic acid ethylene oxide, propylene oxide, or a mixture of ethylene oxide and propylene oxide and have the formula

In the above formulae, R¹³ is a straight or branched chain aliphatic group having from 6 to 30 carbon atoms, subscript s is from 0-100, subscript w is from 0-100, and the sum of subscripts s and w is from 1 to 100. The term “aliphatic” is meant to represent saturated alkyl hydrocarbons, unsaturated alkylene hydrocarbons or mixtures thereof. Alternatively, the alkylene oxide is selected from ethylene oxide, propylene oxide, and mixtures thereof.

The surfactants may be selected from anionic, cationic, nonionic or amphoteric materials. Mixtures of one or more of these may also be used. Suitable anionic organic surfactants include alkali metal soaps of higher fatty acids, alkyl aryl sulphonates, for example sodium dodecyl benzene sulphonate, long chain (fatty) alcohol sulphates, olefin sulphates and sulphonates, sulphated monoglycerides, sulphated esters, sulphonated ethoxylated alcohols, sulphosuccinates, alkane sulphonates, phosphate esters, alkyl isethionates, alkyl taurates and/or alkyl sarcosinates. Suitable cationic organic surfactants include alkylamine salts, quaternary ammonium salts, sulphonium salts and phosphonium salts. Suitable nonionic surfactants include silicones such as those described as Surfactants 1-6 in EP 638346, particularly siloxane polyoxyalkylene copolymers, condensates of ethylene oxide with a long chain (fatty) alcohol or (fatty) acid, for example C₁₄₋₁₅ alcohol, condensed with 7 moles of ethylene oxide (Dobanol® 45-7), condensates of ethylene oxide with an amine or an amide, condensation products of ethylene and propylene oxides, esters of glycerol, sucrose or sorbitol, fatty acid alkylol amides, sucrose esters, fluoro-surfactants and fatty amine oxides. Suitable amphoteric organic detergent surfactants include imidazoline compounds, alkylaminoacid salts and betaines. It is more preferred that the organic surfactants are nonionic or anionic materials. Of particular interest are surfactants which are environmentally acceptable.

A branched silicone glycol is formed by the reaction of a branched polysiloxane that contains an unreacted Si—H group. For example, forming a branched polysiloxane of the structure (VII) above, having an unreacted Si—H group. The Si—H group of the branched structure, is shown in structure (VIIa) below wherein the blocked Si—H groups are identified in Structure (VIIa) as “blocked” and will react with a polyoxyalkylene compound having a formula selected from

Vi-CH₂—O-(EO)ₜ—(PO)ᵤ—(BO)ᵥ—H,

Vi-CH₂—O-(EO)ₜ—(PO)ᵤ—H,

Vi-CH₂—O-(EO)ₜ—(BO)ᵥ—H,

Vi-CH₂—O—(PO)ᵤ—(BO)ᵥ—H,

Vi-CH₂—O-(EO)ₜ—H,

Vi-CH₂—O—(BO)ᵥ—H, and

Vi-CH₂—O—(PO)ᵤ—H.

In the above formulae, EO, PO, ands BO denote ethylene oxide, propylene oxide, and butylene oxide groups, respectively. Subscript t is an integer of from greater than zero up to 150, and alternatively from 1 to 100, alternatively from 5 to 50. Subscript u is an integer of from greater than zero up to 150, and alternatively from 1 to 100, alternatively from 5 to 50. Subscript v is an integer of from greater than zero up to 150, and alternatively from 1 to 100, alternatively from 1 to 50.

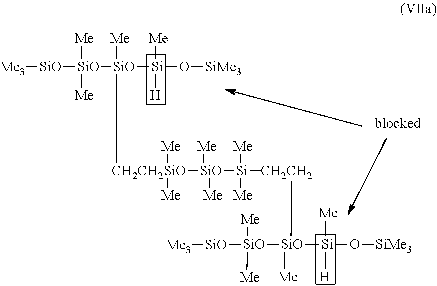

When the polyoxyalkylene compound is Vi-CH₂—O-(EO)ₜ—H, the above blocked portion of the branched silicone glycol will have the structure within the blocks as —Si—CH₂CH₂CH₂—O-(EO)ₜ—H.

### (D) The Optional Hydroxy Compound

The hydroxy compound is an optional component and is selected from a glycol and water and mixtures thereof. The glycol is selected from ethylene glycol, propylene glycol, the isomeric butylene glycols, and the isomeric pentylene glycols. The glycol may also be a polyalkylene glycol. Examples of general polyalkylene glycols used singly or in combination as the hydroxy compound are, but not limited to, a polymer of ethylene glycol, propylene glycol, trimethylene glycol, 1,4-butanediol, 1,5-pentanediol, 1,6-hexanediol, 1,7-heptanediol, 1,8-octanediol, 1,9-nonanediol, 1,10-decanediol, 1,2-octanediol, 1,2-decanediol, butanoyl-alpha-glycol, 1,3-butanediol, trans-2-butene-1,4-diol, 2-butyne-1,4-diol, 2,4-pentanediol, 2,5-hexanediol, 2-methyl-1,3-pentanediol, hexylene glycol, 2,3-dimethyl-2,3-butanediol, 2,4-heptanediol, 2,2-diethyl-1,3-propanediol, 2-ethyl-1,3-hexanediol, 2-ethyl-2-butyl-1,3-propanediol, diethylene glycol, triethylene glycol, tetraethylene glycol, dipropylene glycol, 1,2-cyclononanediol, 1,2-cyclodecanediol, or mixtures thereof. Alternatively, the polyalkylene glycols are polyethylene glycol and polypropylene glycol. Polyethylene glycol has the formula H(OCH₂CH₂)_{w}OH wherein subscript w is from 2 to 200. Polypropylene glycol has the formula H[OCH₂CH(CH₃)]ₓOH wherein subscript x is from 2 to 150.

In another embodiment, the present invention also relates to a process for preparing a silicone composition which comprises the steps of:

combining (A) a silicone based antifoam agent, (B) a carboxy containing silicone, and optionally at least one of (C) an emulsifier selected from a silicone polyether emulsifier and an organic emulsifier, and mixtures thereof, and (D) a hydroxy compound selected from a glycol and water and mixtures thereof.

The process steps are further defined in the examples below.

### Preparation of Component (A)

### Example (A)-1

Combined together were 6% by weight treated precipitated silica (Sipernat® D10) and 1% R972 partially hydrophobic silica (both supplied by Degussa). The contents were dispersed in 86.3% polydiorganosiloxane fluid having a degree of polymerisation of 60 and comprising 80 mole % methyl ethyl siloxane groups, 20 mole % methyl 2-phenylpropyl (derived from α-methylstyrene) siloxane groups and 1 mole % divinyl crosslinking groups. The mean number of carbon atoms in the groups R in the polydiorganosiloxane is 2.2. A 6.7% by weight of a 60% by weight solution of an organosiloxane resin having trimethyl siloxane M units and SiO₂ Q units in an MQ ratio of 0.651 in octyl stearate (70% solid) was added. The mixture was homogenised through a high shear mixer to form the foam control compound component (A).

### Example (A)-2

Example (A)-2 is a silicone based antifoam agent containing a mixture of both branched and linear polysiloxanes. Combined together were 22.8 parts of a polydimethylsiloxane having terminal vinyl groups and with a viscosity of 12,500 mPa s and a filler, 0.6 parts of a trimethylsiloxy capped siloxane MQ resin of a number average molecular weight 4,700 containing less than 1 wt % of silicon bonded hydroxyl group, and having a M:Q molar ratio of 48:52 dispersed in a polydimethylsiloxane fluid having a viscosity of 1,000 mPa s, 0.2 parts of a polysiloxane having the average formula of MD₈D^{R}₃M, where M, D, and DR represent the (CH₃)₃SiO_{1/2}, (CH₃)₂SiO, and (CH₃)HSiO siloxy units respectively, and 3.2 parts Sipernat® D10. The contents were stirred, followed by the addition of a platinum catalyst. Stirring was continued until the contents gel. Then added were 73 parts of a linear polydimethylsiloxane fluid with a viscosity of 1,000 mPa s.

### Example (A)-3

Example (A)-3 is a silicone based antifoam agent containing a mixture of both branched and linear polysiloxanes that further are dispersed in a silicone polyether emulsifier. Combined together were 20 parts of a polysiloxane polyether having a degree of polymerisation of 110 and comprising 9 mole % EO₁₈PO₁₈ groups and 0.5 mole % divinyl crosslinking groups, and 20 parts component (C) emulsifier as Tergitol L-62. The contents were stirred and cooled. Then added were 15 parts of a silicone based antifoam agent containing a mixture of branched and linear polysiloxanes and silica, where branching is between polysiloxanes containing hydrogen and vinyl functions as described in Example (A)-2 above, and 45 parts of a silicone based antifoam agent containing a mixture of branched and linear polysiloxanes and silica, where branching is between polysiloxanes containing hydroxy functions as described in Example 1 of U.S. Pat. No. 4,639,489.

### Preparation of Component (B)

### Example (B)-1

Added to a reaction vessel were 170 parts toluene and 400 parts 10-undecenoic acid. The contents were stirred and slowly added were 161 parts hexamethyldisilizane. After completion of the addition, the contents were heated to 100° C. and held for 3 hours. The contents were stripped to remove any by products, solvent, and unreacted reactants to give a residue component (B)(a). The contents were cooled to 40° C. and added to component (B)(a) was an equimolar amount of an organohydrogenpolysiloxane having a degree of polymerization of 400 and comprising 5 mole % Si—H unit diluted in toluene. The temperature was held at 40° C. for two hours after the addition of a platinum catalyst to form component (B)(b). The contents were heated to 60° C. and a molar amount of methyl alcohol was added while stirring for two hours. The contents were heated to 120° C. under a vacuum less that 30 torr to give component (B).

### Examples that Use the (A), (B), and Optional (C) and (D) Components

The present invention contains at a minimum components (A) and (B). In this embodiment, the (A):(B) weight ratio is from 90-99.9 parts (A) to 0.1-10 parts (B), alternatively from 95-99.9 parts (A) to 0.1-5 parts (B), and alternatively from 97-99.9 parts (A) to 0.1-3 parts (B).

When the present invention contains components (A), (B), and (C), (A) is present at from 30-70 parts, alternatively at from 40-60 parts, and alternatively at from 45-55 parts of the (A), (B), (C) composition. (B) is present at from 0.1-5 parts, alternatively at from 0.5-4 parts, and alternatively at from 1-3 parts of the (A), (B), (C) composition. (C) is present at from 30-70 parts, alternatively at from 35-65 parts, and alternatively at from 40-55 parts of the (A), (B), (C) composition.

When the present invention contains components (A), (B), and (D), (A) is present at from 30-70 parts, alternatively at from 32-65 parts, and alternatively at from 35-55 parts of the (A), (B), (D) composition. (B) is present at from 0.1-5 parts, alternatively at from 0.5-4 parts, and alternatively at from 0.75-3 parts of the (A), (B), (D) composition. (D) is present at from 30-75 parts, alternatively at from 45-70 parts, and alternatively at from 50-60 parts of the (A), (B), (D) composition.

When the present invention contains components (A), (B), (C), and (D), (A) is present at from 15-50 parts, alternatively at from 20-40 parts, and alternatively at from 25-35 parts of the (A), (B), (C), and (D) composition. (B) is present at from 0.1-5 parts, alternatively at from 0.25-4 parts, and alternatively at from 0.5-3 parts of the (A), (B), (C), and (D) composition. (C) is present at from 15-50 parts, alternatively at from 20-40 parts, and alternatively at from 25-35 parts of the (A), (B), (C), and (D) composition. (D) is present at from 30-70 parts, alternatively at from 32-65 parts, and alternatively at from 35-55 parts of the (A), (B), (C), and (D) composition.

The invention having been generally described above, may be better understood by reference to the examples described below. The following examples represent specific but non-limiting embodiments of the present invention.

### Example 1

### Inventive Formulation

The below components were added to a mixing vessel to form a concentrate: 30 parts by weight of Example (A)-2 as component (A), 41 parts by weight component (D) as polypropylene glycol, 20 parts by weight component (C) as Pluronic® L-101, available from BASF, 5 parts by weight component (C) of a polyoxyalkylene alkyl ether identified as Emulgen MS 110, available from Kao Specialities Americas LLC, 3 parts by weight component (C) of a water soluble branched silicone glycol, and 1 part by weight of component (B) as the composition of Example (B)-1. The contents were mixed by stirring at 500 revolutions per minute for 2 hours, until a homogeneous mixture was obtained. This mixture was further passed through a colloid mill at 40/1000 inch gap to yield a concentrate. Added to 30 parts of this concentrate was 70 parts of water. The contents were stirred at 500 revolutions per minute for 60 minutes to obtain an emulsion. A 200 gram sample of this emulsion was removed and subjected to high shear agitation at 3000 revolutions per minute for 2 minutes. These contents were filtered using a number 120 mesh screen to obtain a filtrate and a retentate. The retentate was dried for 10 minutes at 110° C. and 30 torr.

### Example 2

### Comparative Formulation

The procedure and weights of Example 2 were repeated except that 1 part by weight of component (B) as the composition of Example (B)-1a was replaced with 1 part of a water insoluble linear silicone glycol.

Dilution stability is calculated as a percent of dried retentate as a function of the total weight of the emulsion used from which the retentate is obtained. The lower the percent, the better the stability. Results are shown in Table 1.

TABLE 1
Dilution Shear Stability at Room Temperature

| | Weight Dry Retentate | % Retentate in |
|---|---|---|
| Example No. | (grams) | Emulsion |
| 1 Inventive Formulation | 0.92 | 0.46 |
| 2 Comparison Formulation | 1.81 | 0.91 |

### Example 3

### Inventive Formulation

The below components were added to a mixing vessel to form a concentrate: 30 parts by weight of Example (A)-3 as component (A), 1.43 parts by weight component (C) as polystearyl ether (formed by reacting one mole of stearyl alcohol with two moles of ethylene oxide), 1.43 parts by weight component (C) as polystearyl ether (formed by reacting one mole of stearyl alcohol with 20 moles of ethylene oxide), and 1.43 parts by weight of component (B) as the composition of Example (B)-1. The contents were mixed by stirring at 500 revolutions per minute for 2 hours, until a homogeneous mixture was obtained. Added to 30 parts of this concentrate was 70 parts of water. The contents were stirred at 500 revolutions per minute for 60 minutes to obtain an emulsion.

### Example 4

### Comparative Formulation

The below components were added to a mixing vessel to form a concentrate: 30 parts by weight of Example (A)-3 as component (A), 2.15 parts by weight component (C) as polystearyl ether (formed by reacting one mole of stearyl alcohol with two moles of ethylene oxide), 2.15 parts by weight component (C) as polystearyl ether (formed by reacting one mole of stearyl alcohol with 20 moles of ethylene oxide). There is no component B in this comparative formulation. The contents were mixed by stirring at 500 revolutions per minute for 2 hours, until a homogeneous mixture was obtained. Added to 30 parts of this concentrate was 70 parts of water. The contents were stirred at 500 revolutions per minute for 60 minutes to obtain an emulsion.

In the pulp making process, approximately 7 tons of black liquor are produced in the manufacture of one ton of pulp. The black liquor is an aqueous solution of lignin residues, hemicellulose, and the inorganic chemicals used in the process. The black liquor comprises 15% solids by weight of which 10% are inorganic and 5% are organic. Normally the organics in black liquor are 40-45% soaps, 35-45% lignin and 10-15% other organics. The organic matter in the black liquor is made up of water/alkali soluble degradation components from the wood. Lignin is degraded to shorter fragments having a sulfur content at 1-2% and sodium content at about 6% of the dry solids. Cellulose and hemicellulose is degraded to aliphatic carboxylic acid soaps and hemicellulose fragments. The extractives give tall oil soap and crude turpentine. The soaps contain about 20% sodium.

A sample of 2 grams of the emulsions of Examples 3 and 4 were each added to a 100 gram sample of a black liquor composition, wherein 10 grams of black liquor is added to 90 grams of water to obtain the black liquor composition. The inventive emulsion Example 3 in the black liquor composition is identified as Example 5 and the comparative emulsion Example 4 in the black liquor composition is identified as Example 6. The two example formulations were aged for four days at 80° C. The formulations were filtered through a number 120 mesh screen to obtain a filtrate and a retentate. The retentate was dried at 150° C. and weighed. Results are shown in Table 2.

TABLE 2
Dilution Shear Stability at High Temperature

| | Weight Dry Retentate | % Retentate in |
|---|---|---|
| Example No. | (grams) | Emulsion |
| 5 Inventive Formulation | 0.0868 | 4.34 |
| 6 Comparison Formulation | 0.6386 | 31.93 |

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

1. A silicone composition comprising:
(A) a silicone based antifoam agent;
(B) a carboxy functional silicone; and
optionally at least one of;
(C) an emulsifier selected from a silicone polyether emulsifier, an organic emulsifier, or mixtures thereof, or
(D) a hydroxy compound selected from a glycol, water, or mixtures thereof.

2. The silicone composition of claim 1, wherein the silicone based antifoam agent (A) comprises a mixture of:
(a) 100 parts by weight of a polysiloxane fluid wherein the polysiloxane fluid is a linear polysiloxane fluid, a branched polysiloxane fluid, or mixture thereof; and
(b) from 1 to 15 parts by weight of a hydrophobic filler dispersed in the polysiloxane fluid.

3. The silicone composition according to claim 2, wherein the polysiloxane fluid (A)(a) is a linear polydiorganosiloxane of the formula 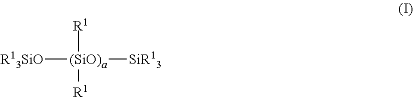
wherein R¹ is independently an alkyl group having from 1 to 36 carbon atoms, an alkenyl group having from 2 to 6 carbon atoms, an aryl group, an aralkyl group having up to 36 carbon atoms, a hydroxy group, or an alkoxy group wherein the alkyl group of the alkoxy group has from 1 to 36 carbon atoms and subscript a is an integer of from 1 up to 2000.

4. The silicone composition according to claim 3, wherein R¹ is methyl.

5. The silicone composition according to claim 2, wherein the polysiloxane fluid (A)(a) is a branched polydiorganosiloxane of the formula 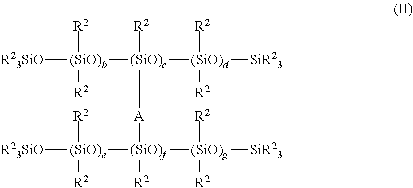
wherein R² is independently an alkyl group having from 1 to 36 carbon atoms, an alkenyl group having from 2 to 6 carbon atoms, an aryl group, an aralkyl group having up to 36 carbon atoms, a hydroxy group, or an alkoxy group wherein the alkyl group of the alkoxy group has from 1 to 36 carbon atoms, subscript b is an integer of from 1 up to 1000, subscript c is an integer of from greater than zero up to 30, subscript d is an integer of from 1 up to 1000, subscript e is an integer of from 1 up to 1000, subscript f is an integer greater than zero up to 30, subscript g is an integer of from 1 up to 1000, A is a group selected from 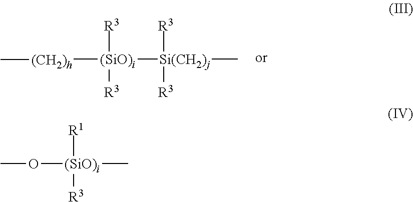
wherein R³ is independently an alkyl group having from 1 to 36 carbon atoms or an aryl group or aralkyl group having up to 36 carbon atoms, subscript h is an integer of from 2 up to 10, subscript i is an integer of from 1 up to 2000, and subscript j is an integer of from 2 up to 10.

6. The silicone composition according to claim 5, wherein R² and R³ are methyl.

7. The silicone composition according to claim 2, wherein the polysiloxane fluid is the branched polysiloxane fluid, and wherein the branched polysiloxane fluid is a resin comprising at least one of compounds a) to d):
a) an organosilicon compound of the general formula R¹⁴_{α}SiX_{4-α}, wherein R¹⁴ is a monovalent hydrocarbon group having 1 to 5 carbon atoms, X is a hydrolyzable group selected from —OR¹⁵ or —OR¹⁶OR¹⁷, wherein R¹⁶ is a divalent hydrocarbon group having 1 to 5 carbon atoms and R¹⁵ or R¹⁷ are each hydrogen or a monovalent hydrocarbon group having 1 to 5 carbon atoms, the average value of subscript α does not exceed 1;
b) a partially hydrolyzed condensate of the organosilicon compound a);
c) a siloxane resin consisting essentially of (CH₃)₃SiO_{1/2} and SiO₂ units and having a (CH₃)₃SiO_{1/2}SiO₂ ratio of 0.4/1 to 1.2/1; or
d) a condensate of the siloxane resin c) with the compound a) or b).

8. The silicone composition according to claim 3, wherein the linear polydiorganosiloxane is a polysiloxane comprising at least 10% diorganosiloxane units of the formula 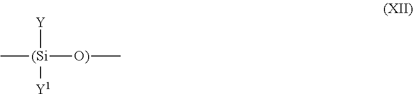
and up to 90% diorganosiloxane units of the formula 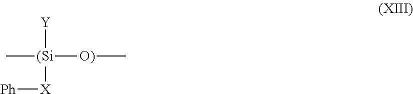
wherein X denotes a divalent aliphatic organic group bonded to silicon through a carbon atom; Ph denotes an aromatic group; Y denotes an alkyl group having 1 to 4 carbon atoms; and Y¹ denotes an aliphatic hydrocarbon group having 1 to 24 carbon atoms.

9. A silicone composition according to claim 3, wherein the linear polydiorganosiloxane is a polysiloxane comprising 50 to 100% diorganosiloxane units of the formula 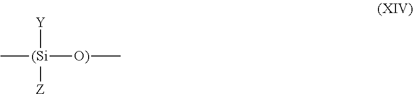
and optionally up to 50% diorganosiloxane units of the formula 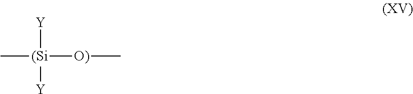
wherein Y denotes an alkyl group having 1 to 4 carbon atoms and Z denotes an alkyl group having 6 to 18 carbon atoms.

10. The silicone composition according to claim 2, wherein the silicone based antifoam agent (A) further comprises at least one of:
(c) from 10 to 125 parts by weight of a polydiorganosiloxane having at least one terminal hydroxy group and at least 40 silicon atoms; or
(d) from 0.5 to 10 parts by weight of an organosilicon resin.

11. The silicone composition according to claim 10, wherein the antifoam agent (A) further comprises the polydiorganosiloxane (A)(c), and wherein the polydiorganosiloxane (A)(c) has the formula 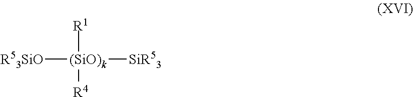
wherein R⁴ is independently a monovalent hydrocarbon group or a substituted monovalent hydrocarbon group having from 1 to 20 carbon atoms, R⁵ is independently a monovalent hydrocarbon group or a substituted monovalent hydrocarbon group having from 1 to 20 carbon atoms, or a hydroxy group, with the proviso that at least one R⁵ is a hydroxy group, and subscript k is less than 1500.

12. The silicone composition according to claim 10, wherein the antifoam agent (A) further comprises the organosilicon resin (A)(d), and wherein the organosilicon resin (A)(d) comprises siloxane units of the formula R⁶_{y}SiO_{(4-y)/2} in which R⁶ is a hydroxyl group or a monovalent hydrocarbon group having from 1 to 6 carbon atoms and subscript y has an average value of from 0.5 to 2.4.

13. The silicone composition according to claim 1, wherein the carboxy functional silicone (B) is of the formula
R⁸₂R⁹SiO(R⁸R⁹SiO)ₗ(R⁸₂SiO)ₘSiR⁹R⁸₂ or (XVII)
R⁸₂R⁹SiO(R⁸R⁹SiO)ₗSiR⁹R⁸₂ (XVIII)
wherein R⁸ is an alkyl group having from 1 to 20 carbon atoms, R⁹ is independently selected from R⁸ and R¹⁰COOH, wherein R¹⁰ is a divalent hydrocarbon group having from 1 to 20 carbon atoms, with the proviso that at least one R⁹ is R¹⁰COOH, subscript l is from 0 up to 1000, and subscript m is from 1 up to 400.

14. The silicone composition according to claim 1, wherein the emulsifier (C) is present and is selected from a silicone polyether emulsifier, an organic emulsifier, or mixtures thereof.

15. The silicone composition according to claim 14, wherein the emulsifier (C) is the silicone polyether emulsifier and is selected from 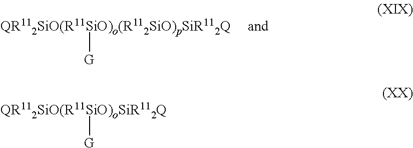
wherein R¹¹ is a monovalent hydrocarbon group having from 1 to 20 carbon atoms, Q is independently R¹¹ or G, with the proviso that at least one Q is G, subscript o has a value of 0 to 150, subscript p has a value of 1 to 400 and G is a polyoxyalkylene group having its formula selected from 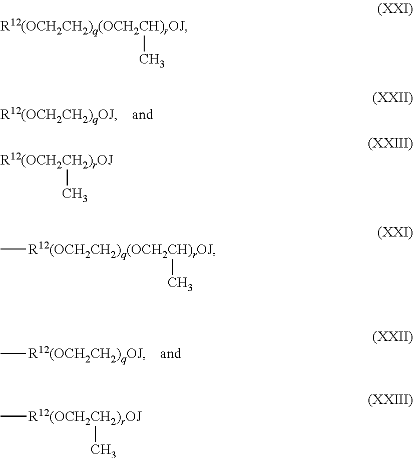
wherein R¹² is a divalent hydrocarbon group having 1 to 20 carbon atoms, subscript q has an average value of about 1 to 50, subscript r has an average value of 1 to about 50, and J is selected from the group consisting of hydrogen, an alkyl radical having 1 to 6 carbon atoms and an acyl group having 2 to 6 carbon atoms.

16. The silicone composition according to claim 14, wherein the emulsifier (C) is the organic emulsifier and is selected from an alkoxylated alcohol of the formula 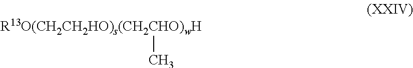
and an alkoxylated carboxylic acid of the formula 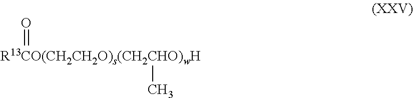
wherein R¹³ is a straight or branched chain aliphatic group having from 6 to 30 carbon atoms, subscript s is from 0 to 100, subscript w is from 0 to 100, and the sum of subscripts s and w is from 1 to 100.

17. The silicone composition according to claim 1, wherein the hydroxy compound (D) is present and is the glycol.

18. The silicone composition according to claim 17, wherein the glycol is selected from ethylene glycol, propylene glycol, the isomeric butylene glycols, and the isomeric pentylene glycols.

19. The silicone composition according to claim 17, wherein the glycol is selected from a polymer of ethylene glycol, propylene glycol, trimethylene glycol, 1,4-butanediol, 1,5-pentanediol, 1,6-hexanediol, 1,7-heptanediol, 1,8-octanediol, 1,9-nonanediol, 1,10-decanediol, 1,2-octanediol, 1,2-decanediol, butanoyl-alpha-glycol, 1,3-butanediol, trans-2-butene-1,4-diol, 2-butyne-1,4-diol, 2,4-pentanediol, 2,5-hexanediol, 2-methyl-1,3-pentanediol, hexylene glycol, 2,3-dimethyl-2,3-butanediol, 2,4-heptanediol, 2,2-diethyl-1,3-propanediol, 2-ethyl-1,3-hexanediol, 2-ethyl-2-butyl-1,3-propanediol, diethylene glycol, triethylene glycol, tetraethylene glycol, dipropylene glycol, 1,2-cyclononanediol, 1,2-cyclodecanediol, or mixtures thereof.

20. A process for preparing a silicone composition which comprises the step of: combining
(A) a silicone based antifoam agent,
(B) a carboxy functional silicone, and
optionally at least one of
(C) an emulsifier selected from a silicone polyether emulsifier, an organic emulsifier, or mixtures thereof, or
(D) a hydroxy compound selected from a glycol, water, or mixtures thereof.
